(19) United States
(12) Patent Application Publication
(10) Pub. No.: US 2022/0067639 A1
(43) Pub. Date: Mar. 3, 2022

(54) Native Mobile Application for Tracking Physical Items

(71) Applicant: ServiceNow, Inc., Santa Clara, CA (US)

(72) Inventors: Eric Charles Ferrington, Washington, MI (US); Shantanu Phadke, Santa Clara, CA (US)

(21) Appl. No.: 17/011,199

(22) Filed: Sep. 3, 2020

(51) Int. Cl. G06Q 10/08; H04M 1/725; G06K 7/10; H04W 4/021

(52) U.S. Cl. CPC G06Q 10/087; H04W 4/021; G06K 7/10881; H04M 1/72527

(57) ABSTRACT

A wireless computing device may include a screen, a camera, a communication interface, one or more processors, and persistent storage containing program instructions that cause the one or more processors to execute a native application. The native application may be configured to: receive, by way of a graphical user interface, a selection of a location and a command to initiate a scanning session for physical items in the location; based on initiation of the scanning session, activate the camera, cause images captured by the camera to be displayed on the graphical user interface, and process the images for identifiers of the physical items; transmit, by way of the communication interface and to a storage device, one or more messages containing representations of the identifiers and the location selected; and receive, by way of the graphical user interface, a further command to terminate the scanning session.

### BACKGROUND

Many different types of organizations rely on asset tracking systems to determine the locations physical items, and perform auditing activities on a quarter or yearly basis. However, traditional systems either rely on manual entry to some extent (e.g., users typing identifiers into spreadsheets or filling out checklists) or are generally limited to using specific scanning devices. Further, these systems may not allow multiple technicians to work simultaneously with shared editing of entries, and may be unable to automatically generate new entries when unexpected items are scanned. As a consequence, traditional tracking systems are difficult to use in practice, resulting in more time spent performing audits that often lack the required accuracy.

### SUMMARY

The embodiments herein overcome these and other technical problems by introducing a new tracking system for physical items that uses a custom, native mobile application for scanning physical items and a structured database to store information related to these items as scanned. This allows for a number of innovative new features to be employed.

For example, the native application can be used on virtually any wireless computing device (e.g., smartphone, tablet) with a screen, camera, and wireless communication interface. Thus, special scanning devices are not required. The native application can operate in an online mode, potentially providing information related to scanned items to the database in real time or near real time. The native application can also operate in an offline mode, in which information related to multiple scanned items can batch-uploaded to the database. This facilitates carrying out scans in environments with limited wireless network coverage, as well as environments in which the scanned information needs to be transmitted over a secure network link that is not available in all locations in which the scanning takes place.

Further, multiple technicians carrying out an audit can update the same entries in the database, thus allowing them to take a “divide-and-conquer” approach to larger audits. Also, when an item is scanned and uploaded, its information is immediately viewable in the database by way of a web interface. This permits verifying that items were properly scanned.

Moreover, at the end of a scanning session, the database may reflect the status of each item as one of: expected and scanned, expected but not scanned, scanned but not expected, or a new item. This provides a more comprehensive picture of the audit's outcome than traditional techniques, and may help technicians more easily identify and address unexpected outcomes.

Accordingly, a first example embodiment may involve a wireless computing device that includes a screen, a camera, a communication interface, one or more processors, and persistent storage containing program instructions that cause the one or more processors to execute a native application. The native application may be configured to: receive, by way of a graphical user interface, a selection of a location and a command to initiate a scanning session for physical items in the location; based on initiation of the scanning session, activate the camera, cause images captured by the camera to be displayed on the graphical user interface, and process the images for identifiers of the physical items; transmit, by way of the communication interface and to a storage device, one or more messages containing representations of the identifiers and the location selected, wherein reception of the one or more messages causes the storage device to store the representation of the identifiers along with the location as entries in a table; and receive, by way of the graphical user interface, a further command to terminate the scanning session.

A second example embodiment may involve receiving, by way of a graphical user interface, a selection of a location and a command to initiate a scanning session for physical items in the location, wherein the graphical user interface is of a native application executing on a wireless computing device. The second example embodiment may further involve, possibly based on initiation of the scanning session, activating a camera of the wireless computing device, causing images captured by the camera to be displayed on the graphical user interface, and processing the images for identifiers of the physical items. The second example embodiment may further involve transmitting, by way of a communication interface of the wireless computing device and to a storage device, one or more messages containing representations of the identifiers and the location selected, wherein reception of the one or more messages causes the storage device to store the representation of the identifiers along with the location as entries in a table. The second example embodiment may further involve receiving, by way of the graphical user interface, a further command to terminate the scanning session.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a database schema, in accordance with example embodiments.

FIG. 7A is a message flow diagram, in accordance with example embodiments.

FIG. 7B is another message flow diagram, in accordance with example embodiments.

FIG. 8 is a schematic drawing of a wireless computing device, in accordance with example embodiments.

FIGS. 9A, 9B, 9C, and 9D depict example graphical user interfaces for a wireless computing device, in accordance with example embodiments.

FIG. 10 depicts an example graphical user interface for a server device, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

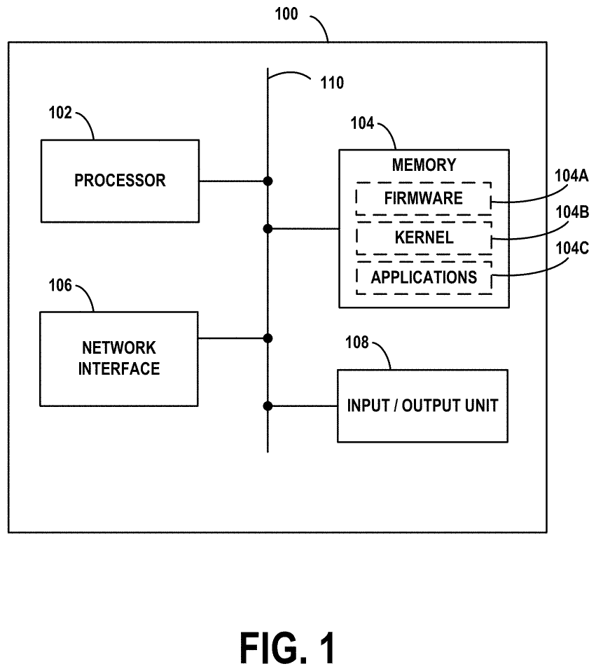

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

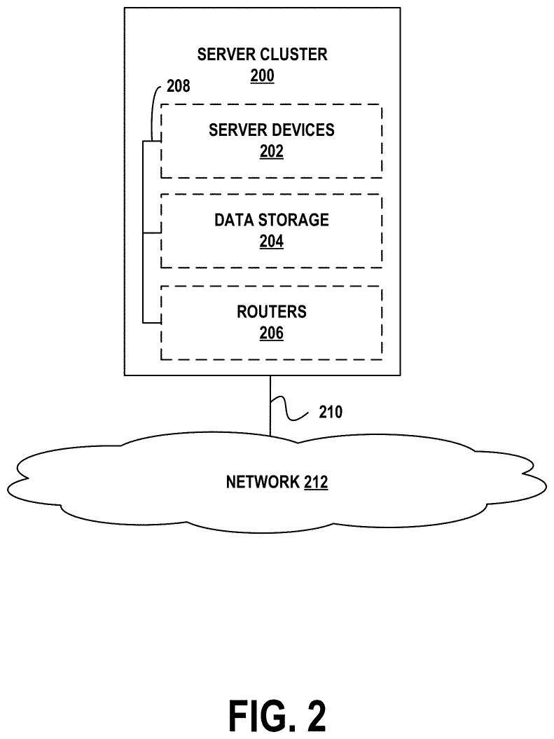

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

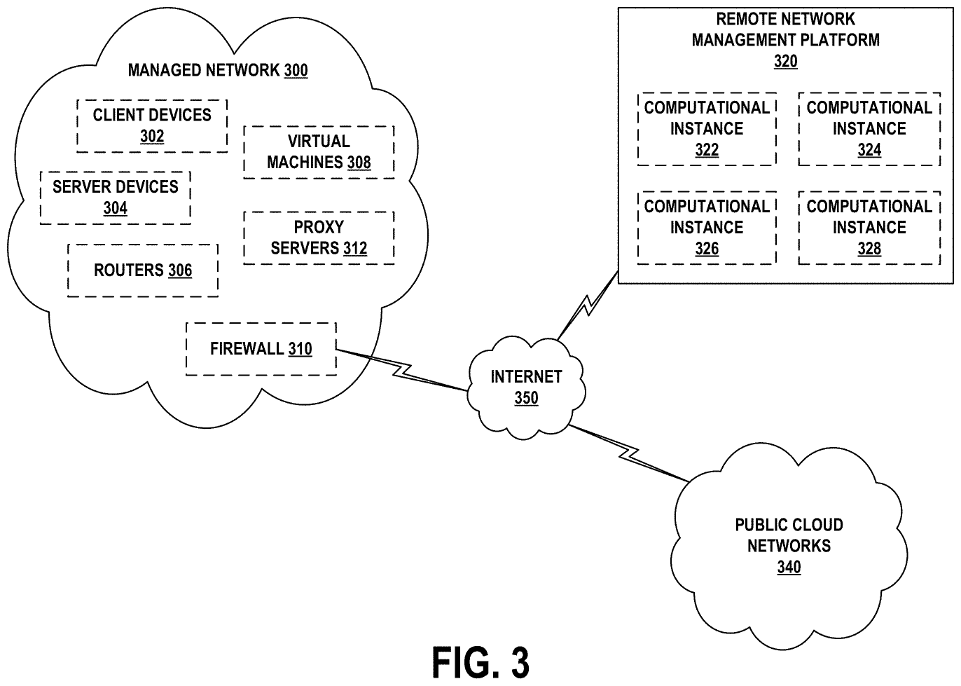

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

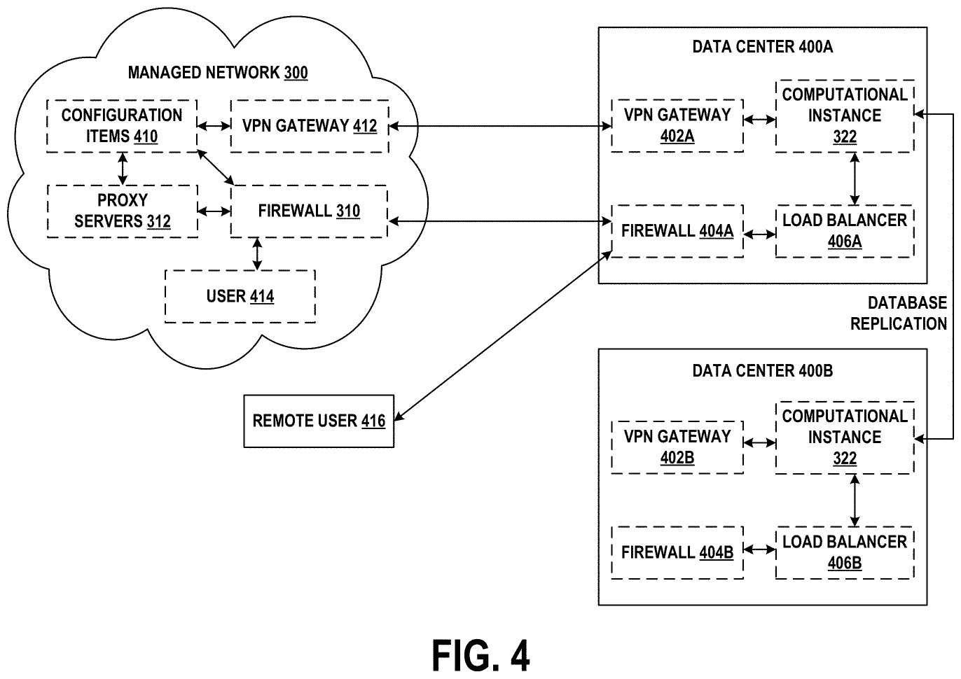

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

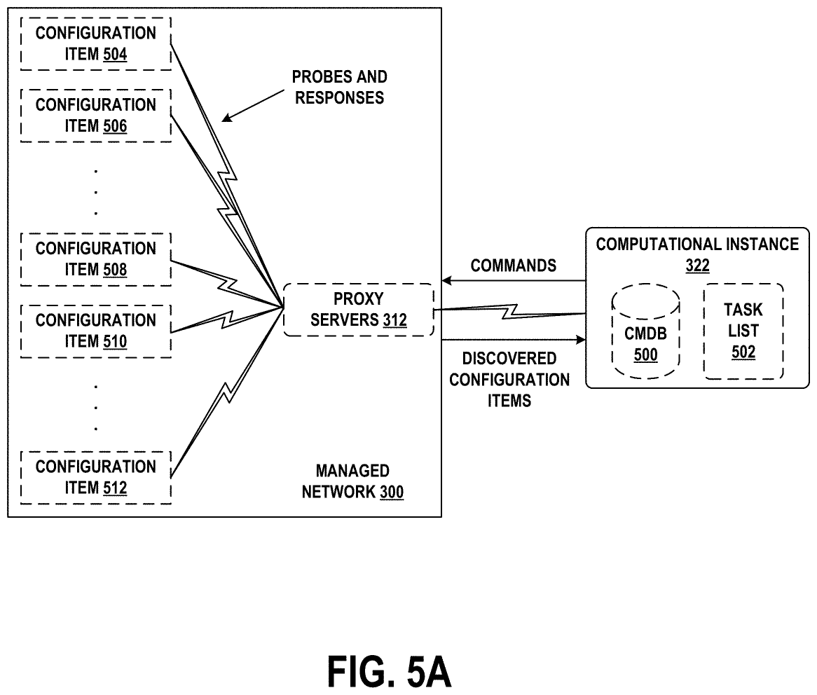

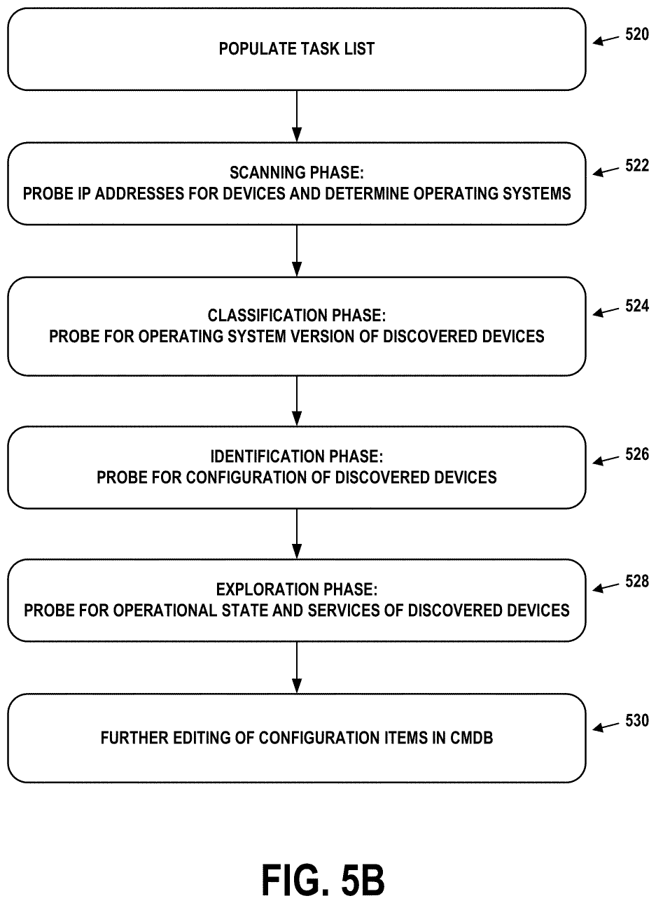

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. PHYSICAL ITEM AUDITS

Various types of industries make use of regularly-scheduled or ad hoc auditing procedures. The auditing may be carried out on physical items, such as products, samples, supplies, or other types of items in inventory. These items, or their respective packaging, may each be labeled with an asset tag that includes a bar code, UPC code, QR code, alphanumeric code, or some other type of marking that identifies the physical item.

For example, a warehouse may be receiving and shipping physical items on most days of the year. The asset tags of these physical items may be scanned when the items arrive at the warehouse and when the items leave the warehouse, with the results of the scanning being entered into persistent storage (e.g., a spreadsheet, list, database, etc.). Thus, the totality of the warehouse's current inventory should be the physical items that have been received at the warehouse, but have not yet left. Nonetheless, in the normal course of activities, items can be misplaced, lost, stolen, broken, or otherwise destroyed. As a result, regular audits of the actual contents of the warehouse versus what is expected to be in the warehouse can identify any discrepancies so that the organization can take remedial action.

Similarly, a retail store may maintain an inventory of physical items for sale (e.g., in a stockroom). The asset tags of these items may be scanned when they arrive at the store to add them to inventory. When an item is sold, it is removed from inventory. While the store may periodically audit the physical items on hand, it may also do so on an ad hoc basis in response to a fire, flood, looting, or other deleterious events.

But existing systems for the tracking of physical items are limited in functionality. These are often stand-alone systems requiring specific devices to perform the scanning, and with the results of the scanning being entered into a flat file or spreadsheet. Such systems can become unwieldy when multiple technicians are simultaneously performing scanning activities, when unexpected items are scanned, and under other circumstances.

The embodiments herein overcome these and other drawbacks of existing systems by integrating physical item tracking functionality into computational instances of a remote network management platform. As an example, physical items related to computer hardware can be automatically incorporated into a CMDB and represented as configuration items as appropriate.

Further, these embodiments introduce a native mobile application for scanning the asset tags of physical items. The native application can operate on any wireless computing device (e.g., smartphone, tablet) with a screen, camera, and wireless communication interface. The native application can operate in an online mode, in which representations of scanned asset tags are transmitted to a computational instance in real time or near real time of submission (here, real time may be within a few seconds of an event, and near real time may be within a few tens of seconds of an event). The native application may also be able to operate in an offline mode in which the representations are transmitted in a batch mode when the wireless computing device is capable of doing so. Thus, the scanning can take place regardless of whether wireless coverage is available. Further, if the wireless computing device needs to be on a secure network in order to upload the representations, its user can continue scanning activities until such a network is available.

The application described herein may be considered “native,” in that it is compiled specifically for a particular type of mobile device and/or mobile device operating system or environment. Native mobile applications have more flexibility in terms of how information is presented than, for example, web-based applications (web apps) that are accessed by way of a web browser and that may execute at least partially within the web browser. Notably, a browser-based web app may be difficult for a user to navigate due to small text size, links that are difficult to activate, and having to access a server in order to change what is being displayed. Native mobile applications can focus on presenting only the information that is deemed to be most important to the user, doing do so with navigation that is intuitive and simple, and might not have to rely on information from a server in order to display new screens or pages of the GUIs.

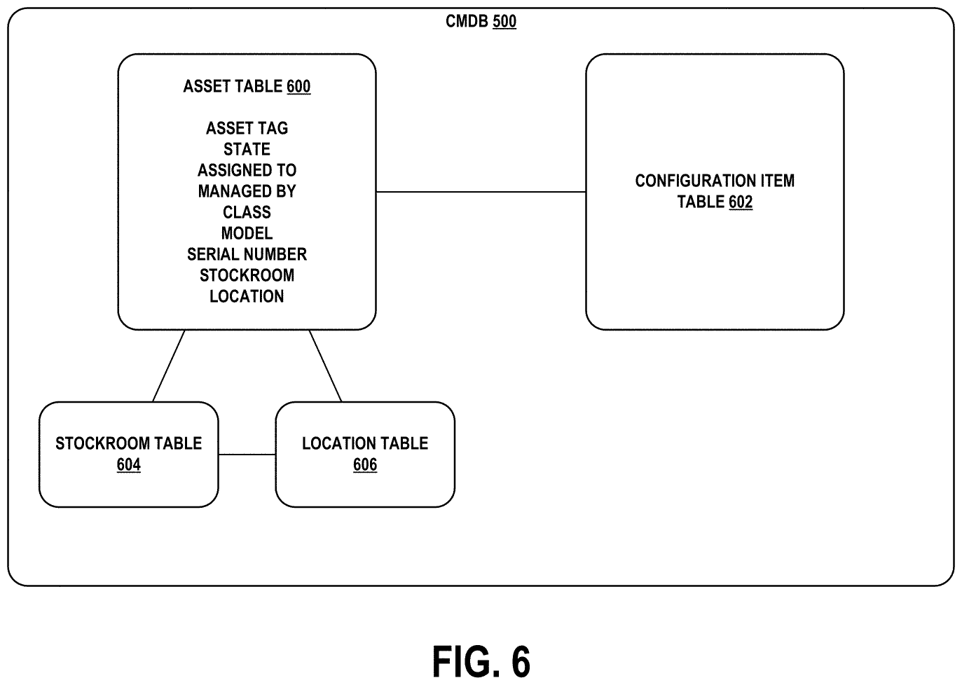

FIG. 6 provides an example database schema for tables within CMDB 500 (or tables in another database) that can store the results from physical item scanning sessions and integrate these results with configuration items. The relationships between the tables in this schema are for purposes of example. More or fewer tables and other types of relationships between tables might exist.

Asset table 600 contains fields that define a specific physical item as an asset. These fields may include, but are not limited to: an asset tag (an alphanumeric string identifying the asset), the state of the asset (e.g., on order, in stock, in transit, in use, in maintenance, retired, missing), assigned to (e.g., identifying a person or group to which the asset is assigned), owned by (e.g., identifying a person or group that has financial responsibility for the asset), class (e.g., hardware, software, or consumable), model (e.g., model number of the asset), serial number, (e.g., serial number of the asset), stockroom (e.g., the stockroom in which the asset is stored), and location (e.g., the location in which the asset resides). Not all of these fields might be populated for all assets. For instance, an asset that is on order or in use may have a blank or null stockroom field. Likewise, the serial number and assigned to field of an asset that is on order might be blank or null because this information is yet to be available. In some cases, the information in asset table 600 can be spread across multiple tables.

Configuration item table 602 represents one or more tables storing configuration items. Some assets in asset table 600 may also be represented (for at least part of their lifecycles) as configuration items. For example, a network switch may be ordered and thus may first appear in asset table 600. When the switch is deployed in a network and discovered by the discovery procedures above, it may also appear in configuration item table 602. In some cases, certain fields of the switch's entry in asset table 600 may be copied to the switch's entry configuration item table 602.

Stockroom table 604 may store information regarding stockrooms in which assets from asset table 600 are physically stored. Fields in stockroom table 604 may include a name of a stockroom, a location of a stockroom, the entity managing the stockroom, the type of stockroom, and the name of a person or group in charge of the stockroom.

Location table 606 may store information regarding physical locations in which assets from asset table are stored. Fields in location table 606 may include a name of the location, a city, a country, and so on.

While both stockroom table 604 and location table 606 define where an asset is physically disposed, they serve different purposes. All stockrooms have locations (even if such relationships are not reflected in CMDB 500), but not all locations have stockrooms. Therefore, an asset can be in a location but not in a stockroom. Generally speaking, stockrooms are more relevant in retail settings while locations are more relevant in warehouse settings or further back in the supply chain.

To that point, there may be relationships defined between entries of these tables. For example, an asset may have a relationship to a configuration item as described above, and may also be disposed in a location. Alternatively, some assets might have relationships with stockrooms, and indirect relationships with locations by way of their respective relationships with stockrooms.

For convenience, the term “location” may be used herein to refer to either a stockroom or a geographical location. Context can be used to determine which type of location is being referenced in any particular instance.

### VI. PHYSICAL ITEM SCANNING

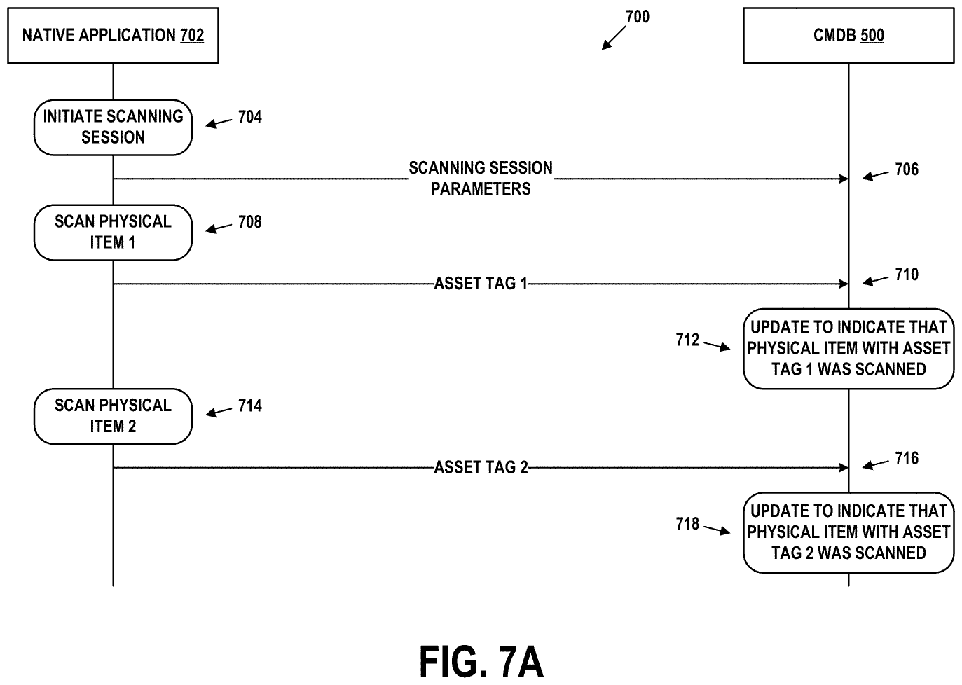

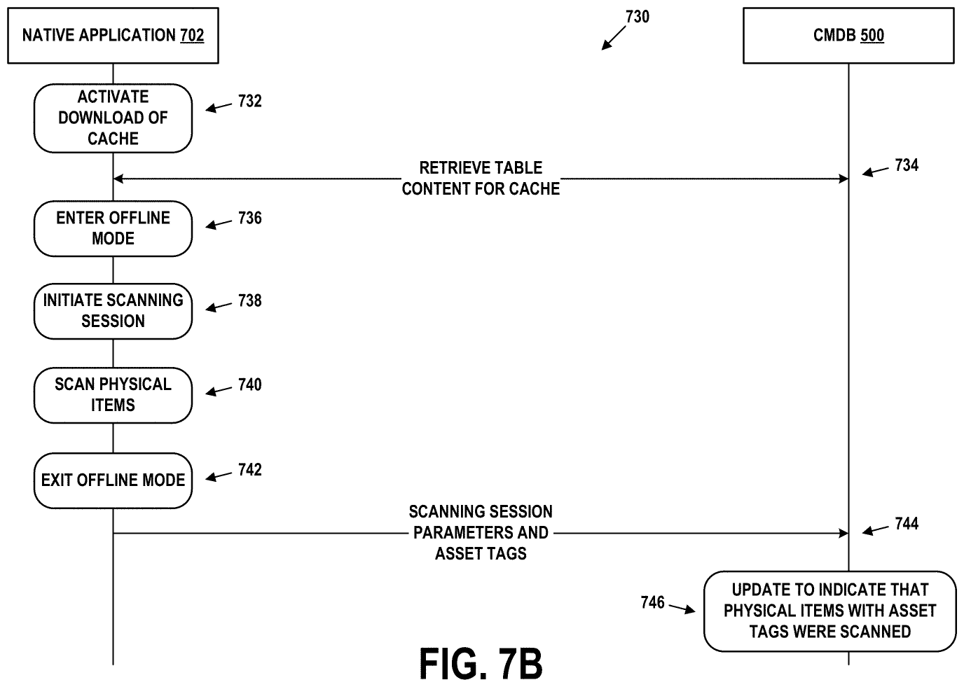

FIGS. 7A and 7B are example message flow diagrams 700 and 730 depicting online mode and offline mode physical item scanning, respectively. The native application may be used in either of these modes, and may include the capability to toggle between these modes as needed.

In FIG. 7A, native application 702 is in communication with CMDB 500. CMDB 500 may be disposed with a computational instance of a remote network management platform. The computational instance may be dedicated to a managed network, and the native application may be associated with the computational instance and utilized by a user associated with the managed network.

At step 704, native application 702 initiates a scanning session. This may involve the user selecting a new scanning session and scanning session parameters. These parameters may include, for example, a stockroom or a location.

At step 706, native application 702 may transmit some or all of the scanning session parameters to CMDB 500. Alternatively, these parameters may be provided in the information transmitted to CMDB 500 in other transmissions, such as those of steps 710 and/or 716.

At step 708, native application 702 may scan a physical item (physical item 1). The scanning may involve the wireless computing device on which native application 702 is executing activating its camera, determining that it has identified an asset tag, and then capturing an image (e.g., a digital photograph) of the asset tag. A representation of the asset tag (e.g., an alphanumeric string) may be derived from the image.

At step 710, native application 702 may transmit the representation of the asset tag to CMDB 500. In some cases, steps 708 and 710 may involve scanning multiple asset tags at once or separately, and then transmitting their respective representations to CMDB 500 in the same message or set of messages.

At step 712, CMDB 500 may receive this representation and store it in the appropriate table or tables. For example, CMDB 500 may create a new entry or update an existing entry in asset table 600. This entry may indicate a stockroom in which the physical item is stored or a location of the physical item.

At step 714, native application 702 may scan another physical item (physical item 2). The scanning may involve the wireless computing device on which native application 702 is executing activating its camera, determining that it has identified an asset tag, and then capturing an image (e.g., a digital photograph) of the asset tag. A representation of the asset tag (e.g., an alphanumeric string) may be derived from the image.

At step 716, native application 702 may transmit the representation of the asset tag to CMDB 500. As noted previously, steps 714 and 716 may involve scanning multiple asset tags at once or separately, and then transmitting their respective representations to CMDB 500 in the same message or set of messages.

At step 718, CMDB 500 may receive this representation and store it in the appropriate table or tables. As noted previously, CMDB 500 may create a new entry or update an existing entry in asset table 600. This entry may also indicate a stockroom in which the physical item is stored or a location of the physical item.

This process of scanning physical items, transmitting representations of their asset tags to CMDB 500, and CMDB 500 storing these representations may continue until the scanning session is ended. For example, the user of native application 702 may manually terminate the scanning session.

In FIG. 7B, native application 702 is again in communication with CMDB 500. In this scenario, offline mode is used. Offline mode is useful when the scanning session is taking place in an area with little or no wireless coverage (e.g., in a basement stockroom, a loading dock, etc.). Further, some organizations require that only secure networks (e.g., specific Wifi networks with strong encryption) are used for uploads. These secure networks may have limited coverage. Thus, even if Wifi or cellular data networks are available, offline mode may still be the ideal method of carrying out a scanning session.

At step 732, native application 702 is activated to download a cache from CMDB 500. This cache may be based on the content of stockroom table 604 and/or location table 606, for example.

At step 734 the content for the cache is downloaded. Having this information cached locally on the wireless computing device and available to native application 702 allows the user to select a new or pre-existing stockroom or location scanning session, for example.

At step 736, native application 702 enters offline mode. In offline mode, native application 702 may refrain from using any communication capabilities of the wireless computing device, and may store all scanned information locally. This scanned information may be stored until it is eventually uploaded to CMDB 500 (e.g., when offline mode is exited) or until it is automatically deleted (e.g., after a pre-determined amount of time, such as 24 or 48 hours).

At step 738, native application 702 initiates a scanning session. This may involve the user selecting a new scanning session and scanning session parameters. These parameters may include, for example, a stockroom or a location selected from the cached information.

At step 740 one or more physical items are scanned. The scanning may involve the wireless computing device on which native application 702 is executing activating its camera, determining that it has identified an asset tag, and then capturing an image (e.g., a digital photograph) of the asset tag. A representation of the asset tag (e.g., an alphanumeric string) may be derived from the image (in some cases, multiple representations may be derived from an image of multiple asset tags). These representations are stored in the wireless computing device.

At step 742, native application 702 exits offline mode. This may cause native application 702 to automatically upload its stored information from the scanning session to CMDB 500.

To that point, at step 744, native application transmits the scanning session parameters (e.g., those selected at step 738) and the representation of the asset tags (e.g., those captured at step 740) to CMDB 500.

At step 746, CMDB 500 updates the appropriate tables with these parameters and representations. As noted previously, CMDB 500 may create new entries and/or update existing entries in asset table 600. These entries may also indicate stockrooms in which the physical items are stored or locations of the physical item.

### VII. EXAMPLE WIRELESS COMPUTING DEVICE

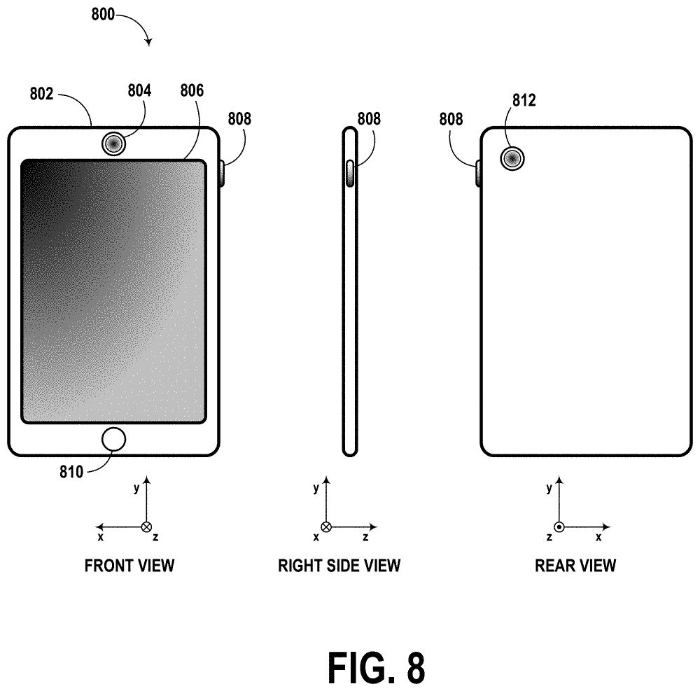

FIG. 8 illustrates the form factor of a wireless computing device 800 on which the native application may execute. Wireless computing device 800 may be, for example, a cellular phone, a tablet computer, network-enabled digital camera, or a wearable computing device. However, other embodiments are possible.

Wireless computing device 800 may include various elements, such as a body 802, a front-facing camera 804, a screen 806, a button 808, and a button 810. Wireless computing device 800 could further include a rear-facing camera 812. Front-facing camera 804 may be positioned on a side of body 802 typically facing a user while in operation, or on the same side as screen 806. Rear-facing camera 812 may be positioned on a side of body 802 opposite front-facing camera 804. Referring to the cameras as front and rear facing is arbitrary, and wireless computing device 800 may include multiple cameras positioned on various sides of body 802.

Screen 806 could represent a cathode ray tube (CRT) display, a light emitting diode (LED) display, an organic light emitting diode (OLED) display, an active-matrix organic light emitting diode (AMOLED) display, a liquid crystal (LCD) display, a plasma display, or any other type of display known in the art. In some embodiments, screen 806 may display a digital representation of a graphical user interface and/or the current image being captured by front-facing camera 804 and/or rear-facing camera 812. Screen 806 may also support touchscreen and/or presence-sensitive functions that may be able to adjust the settings and/or configuration of various aspects of wireless computing device 800.

Front-facing camera 804 may include an image sensor and associated optical elements such as lenses. Front-facing camera 804 may offer zoom capabilities or could have a fixed focal length. In other embodiments, interchangeable lenses could be used with front-facing camera 804. Front-facing camera 804 may have a variable mechanical aperture and a mechanical and/or electronic shutter. Front-facing camera 804 also could be configured to capture still images, video images, or both. Further, front-facing camera 804 could represent a monoscopic, stereoscopic, or multiscopic camera. Rear-facing camera 812 may be similarly or differently arranged. Additionally, front-facing camera 804, rear-facing camera 812, or both, may be an array of one or more cameras.

Either or both of front facing camera 804 and rear-facing camera 812 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the embodiments herein.

Either or both of front-facing camera 804 and rear-facing camera 812 may include or be associated with an ambient light sensor that may continuously or from time to time determine the ambient brightness of a scene that the camera can capture. In some devices, the ambient light sensor can be used to adjust the display brightness of screen 806. When the determined ambient brightness is high, the brightness level of screen 806 may be increased to make the screen easier to view. When the determined ambient brightness is low, the brightness level of screen 806 may be decreased, also to make screen 806 easier to view as well as to potentially save power. Additionally, the ambient light sensor's input may be used to determine an exposure length of an associated camera, or to help in this determination.

Wireless computing device 800 could be configured to use screen 806 as a viewfinder for either front-facing camera 804 or rear-facing camera 812, and thereby capture images of a target object. The captured images could be one or more still images or a video stream. The image capture could be triggered by activating button 808, button 810, pressing a softkey on screen 806, or by some other mechanism. Depending upon the implementation, the images could be captured automatically at a specific time interval, for example, upon pressing button 808, upon appropriate lighting conditions of the target object, upon moving wireless computing device 800 a predetermined distance, or according to a predetermined capture schedule.

Wireless computing device 800 may also contain elements and features of a computing device that are not explicitly shown in FIG. 8, such as a wireless communication interface (e.g., to access local-area and/or wide-area wireless networks), a graphical user interface displayable upon screen 806, one or more processors, one or more units of memory, and so on. Wireless computing device 800 may also be configured to execute one or more native applications (e.g., software applications specifically designed for use on a wireless computing device with intermittent network connectivity and limited screen size), and well as to store data associated with these applications.

Notably, the form factor and components shown for wireless computing device 800 are for purposes of example. A wide variety of other form factors and components may be used.

### VIII. EXAMPLE WIRELESS COMPUTING DEVICE GRAPHICAL USER INTERFACES

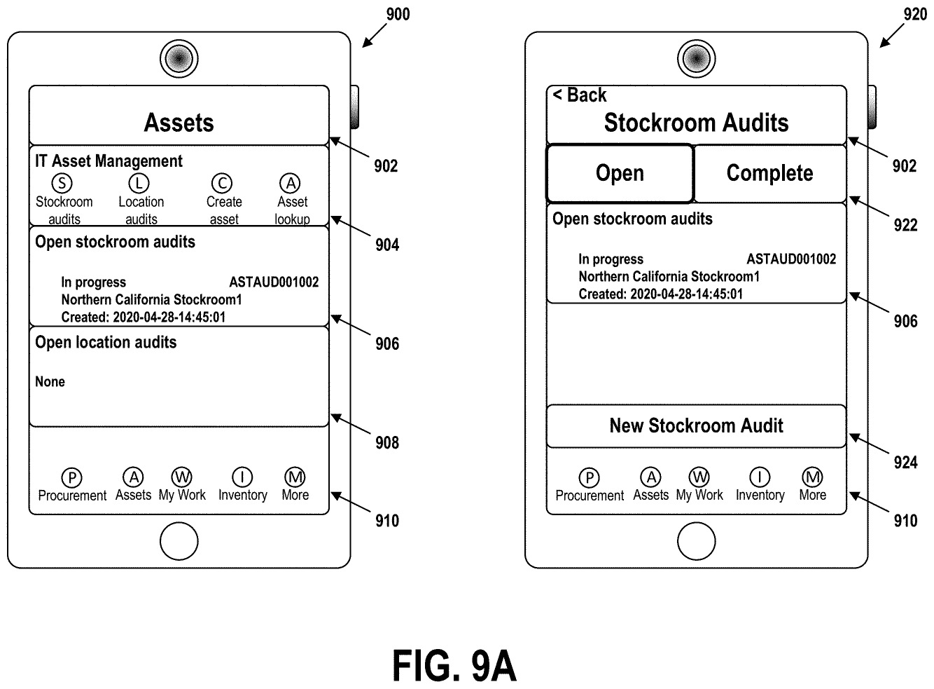

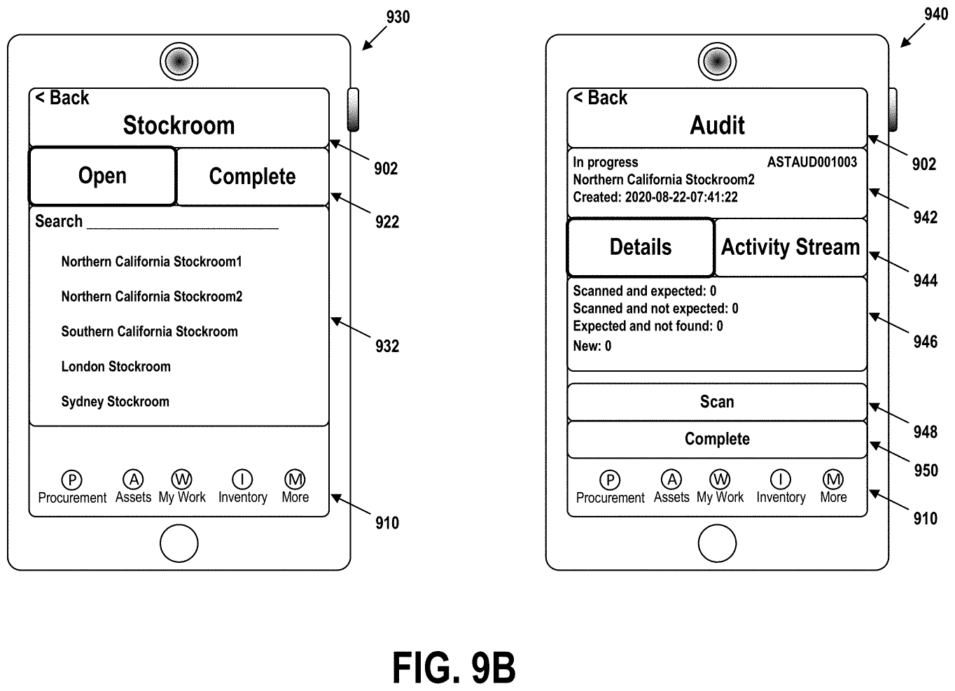

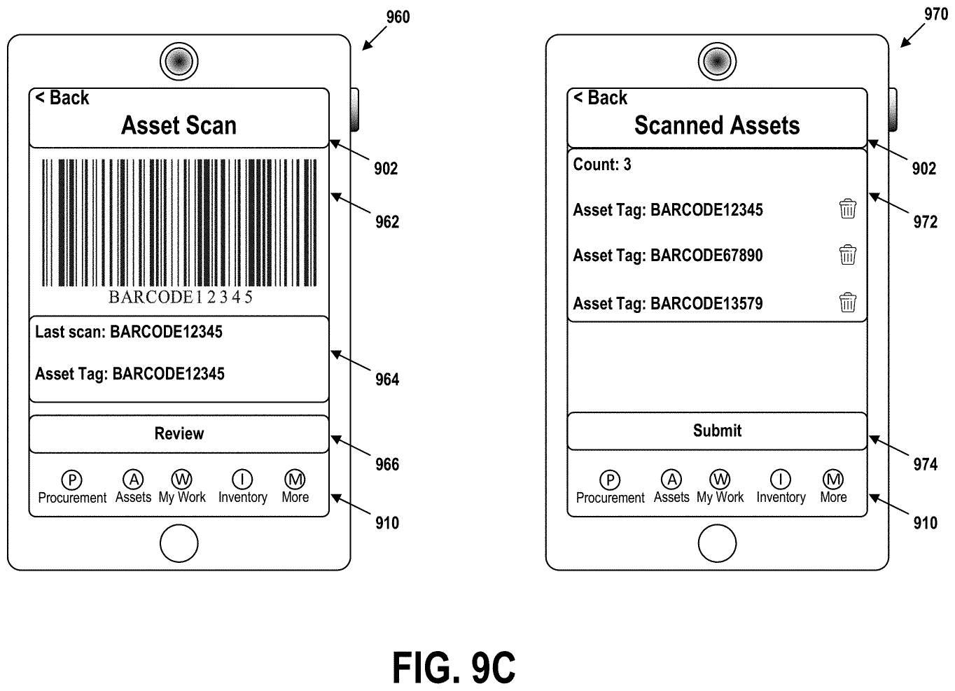

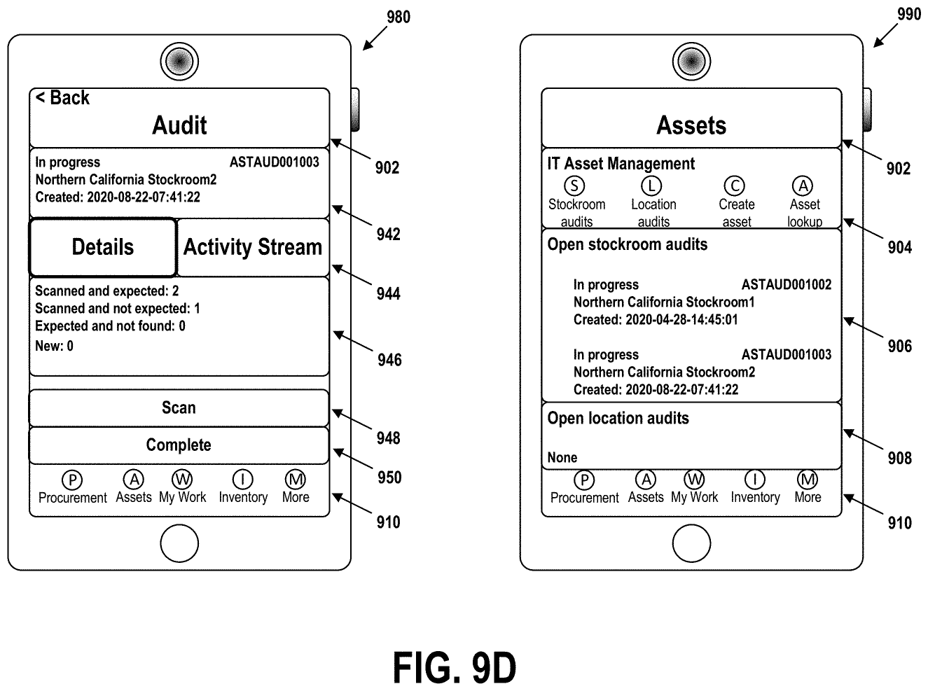

Regardless of form factor, wireless computing device 800 may be installed with and execute the native application in accordance with embodiments herein. The graphical user interfaces in FIGS. 9A-9D provide an example workflow for the native application.

Graphical user interface 900 of FIG. 9A includes title pane 902, menu pane 904, open stockroom audits pane 906, open location audits pane 908, and menu pane 910. Title pane 902 indicates that the assets feature of the native application is selected and being used. Menu pane 904 provides selectable options for using the assets feature: stockroom audits, location audits, creating an asset, and looking up an asset. Open stockroom audits pane 906 shows at least a partial list of open stockroom audits. This list displays one such audit taking place in Northern California Stockroom1. Open location audits pane 908 shows at least a partial list of open location audits. This list is currently empty. Menu pane 910 shows a list of features in the native application. In some embodiments, the assets feature may be highlighted in this list in order to indicate that this feature is being used.

While the focus of FIGS. 9A-9D is on stockroom audits, location audits could proceed with a similar workflow. Thus, these example embodiments are not limited to any particular type of audit.

To begin or continue an audit, the user may select either the stockroom audits or location audits options of menu pane 904. Assuming that the stockroom audits feature is selected, graphical user interface 920 is generated, replacing graphical user interface 900.

Graphical user interface 920 of FIG. 9A includes title pane 902, open/complete toggle 922, open stockroom audits pane 906, new stockroom audit button 924, and menu pane 910. Title pane 902 indicates that the stockroom audits sub-feature of the native application is selected and being used. Open/complete toggle 922 allows the user to switch the display below this part of graphical user interface 920 between open and completed audits. Open/complete toggle 922 is currently set to “open”, so the panes and buttons below open/complete toggle 922 relate to open stockroom audits. To that end, open stockroom audits pane 906 shows the same general information as it did in graphical user interface 900. Setting open/complete toggle 922 to “complete” results in open stockroom audits pane 906 being replaced by a display of complete stockroom audits (not shown). Selection of one of audits in open stockroom audits pane 906 may facilitate adding more assets to that audit. New stockroom audit button 924, when selected, causes the creation of a new stockroom audit. Menu pane 910 shows the same general information as it did in graphical user interface 900.

As noted, assets can be audited by selection of either open stockroom audits 906 or new stockroom audit button 924. Assuming that new stockroom audit button 924 is selected, graphical user interface 930 is generated, replacing graphical user interface 920.

Graphical user interface 930 of FIG. 9B includes title pane 902, open/complete toggle 922, stockroom list pane 932, and menu pane 910. Title pane 902 indicates that the stockroom sub-feature of the native application is selected and being used. Open/complete toggle 922 allows the user to switch the display below this part of graphical user interface 930 between open and completed audits. Open/complete toggle 922 is currently set to “open”, so the panes below open/complete toggle 922 may relate to open stockroom audits. Stockroom list pane 932 displays a searchable list of stockrooms. Each of the listed stockrooms is selectable. Menu pane 910 shows the same general information as it did in graphical user interface 900.

As noted, each of the stockrooms displayed in stockroom list 932 is selectable. Assuming that “Northern California Stockroom2” is selected, graphical user interface 940 is generated, replacing graphical user interface 930.

Graphical user interface 940 of FIG. 9B includes title pane 902, audit description pane 942, details/activity stream toggle 944, audit progress pane 946, scan button 948, complete button 950, and menu pane 910. Title pane 902 indicates that the audit sub-feature of the native application is selected and being used. Audit description pane 942 indicates that “Northern California Stockroom2” is selected, shows that this audit is in progress, shows its unique audit identifier (ASTAUD001003), and a time stamps of when the audit was created (e.g., when the audit began). Details/activity stream toggle 944 allows the user to switch the display below this part of graphical user interface 940 between audit details and a list of activities that have been recorded for the selected audit. Details/activity stream toggle 944 is currently set to “details”, so the panes and buttons below details/activity stream toggle 944 relate to audit details. To that point, audit progress pane 946 shows the number of physical items in the audit that were scanned and expected, scanned and not expected, expected and not scanned, and new. Scan button 948, when selected, facilitates further scanning of physical items. Complete button 950, when selected, facilitates completing the current audit. Menu pane 910 shows the same general information as it did in graphical user interface 900.

As noted, selecting scan button 948 puts the wireless computing device and the native application in a mode in which scanning of physical items can occur. Assuming that scan button 948 is selected, graphical user interface 960 is generated, replacing graphical user interface 940.

Graphical user interface 960 of FIG. 9C includes title pane 902, camera viewfinder pane 962, scan pane 964, review button 966, and menu pane 910. Title pane 902 indicates that asset scan sub-feature of the native application is selected and being used. Particularly, the camera of the wireless computing device has been activated. Camera viewfinder pane 962 displays a still image or a live video stream of images captured by the camera. For example, in graphical user interface 960, camera viewfinder pane 962 displays a captured image containing a barcode. The barcode may have been scanned from a physical item subject to the audit. In some embodiments, an identifier other than a barcode may be used. Scan pane 964 includes the results of the last scan as well as the asset tag identified. While these two pieces of information are the same in graphical user interface 960 they can be different in some scenarios. Review button 966, when selected, allows the user to review the asset tags scanned in the current scanning session. Menu pane 910 shows the same general information as it did in graphical user interface 900.

As noted, selecting review button 966 provides information on the asset tags scanned so far to the user. Assuming that review button 966 is selected, graphical user interface 970 is generated, replacing graphical user interface 960.

Graphical user interface 970 of FIG. 9C includes title pane 902, scanned asset pane 972, submit button 974, and menu pane 910. Title pane 902 indicates that the scanned asset sub-feature of the native application is selected and being used. Scanned asset pane 972 displays a list of asset tags that were scanned in the current scanning session. One or more these asset tags can be deleted by selecting the associated garbage can icon to the right. Submit button 974, when selected, transmits representations of the scanned asset tags (e.g., their identifiers) to the CMDB or an associated server device. Menu pane 910 shows the same general information as it did in graphical user interface 900.

As noted, selecting submit button 974 transmits representations of the scanned asset tags for storage on the computational instance. Assuming that submit button 974 is selected, graphical user interface 980 is generated, replacing graphical user interface 970.

Graphical user interface 980 of FIG. 9D is largely the same as graphical user interface 940 of FIG. 9B, except that audit progress pane 946 has been updated to show that two physical items were scanned and expected, and one physical item was scanned and not expected.

As noted, selecting complete button 950 completes the current audit. Assuming that complete button 950 is selected, graphical user interface 990 is generated, replacing graphical user interface 980.

Graphical user interface 990 of FIG. 9D is largely the same as graphical user interface 900 of FIG. 9A, except that open stockroom audits pane 906 now includes details regarding the audit that was just completed. As such, this audit is still open and can be continued, or it can be closed when there is nothing more to add to it. Further, from graphical user interface 990, a new stockroom audit or a new location audit can be started, among other features.

Also, as discussed previously, the user may cause the native application to enter offline mode before the beginning of the scanning session. Similarly, the user may cause the native application to exit offline mode after the end of the scanning session. Thus, offline mode may be integrated into the workflow of FIGS. 9A-9D even though it is not explicitly shown therein.

### IX. EXAMPLE SERVER DEVICE GRAPHICAL USER INTERFACES

Once an audit or scanning session has been at least partially complete, the native application may transmit the audit results to a server device, such as one that is disposed within a computational instance. The server device may facilitate storing the audit results in a database, such as CMDB 500. Once the audit results are stored in this manner, they can be viewed in real time or near real time by way of a web-based graphical user interface, for example.

Graphical user interface 1000 provides a possible arrangement of information related to an audit or scanning session. It includes indications of the audit name, type (e.g., stockroom or location), stockroom in which the audit took place (if this audit was for a location, this element would be labeled as such), when the audit was scheduled to take place (if applicable), to whom the audit responsibility is assigned, the status of the audit, and the date on which the latest scan for the audit took place.

Additionally, graphical user interface 1000 displays pie chart 1002, showing a spatially-proportional representation of the number of physical items that were scanned and expected, scanned and not expected, expected and not scanned, and new. Section 1004 provides the absolute numbers for each of these categories. These numbers include more physical items than scanned in the example of FIGS. 9A-9D in order to illustrate features of graphical user interface 1000.

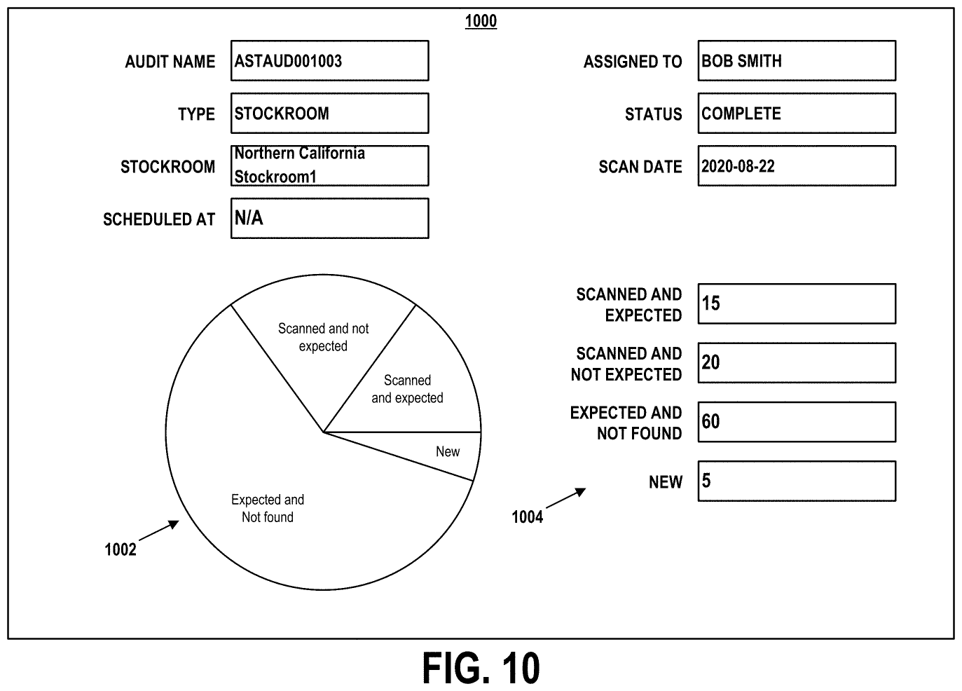

In some embodiments, graphical user interface 1000 may provide additional information. For example, if the user scrolls down from what is shown in FIG. 10, graphical user interface 1000 may display tabbed lists of expected assets and scanned assets. If the user selects an asset from either of these lists, details regarding the asset (such as information that would appear in asset table 600) may be displayed.

Advantageously, graphical user interface 1000 may be updated in real time or near real time with input from one or more wireless computing devices executing the native application. Thus, multiple technicians can participate in the same scanning session simultaneously, uploading representation of scanned physical items as they proceed, or in bulk if offline mode is used.

### X. EXAMPLE OPERATIONS

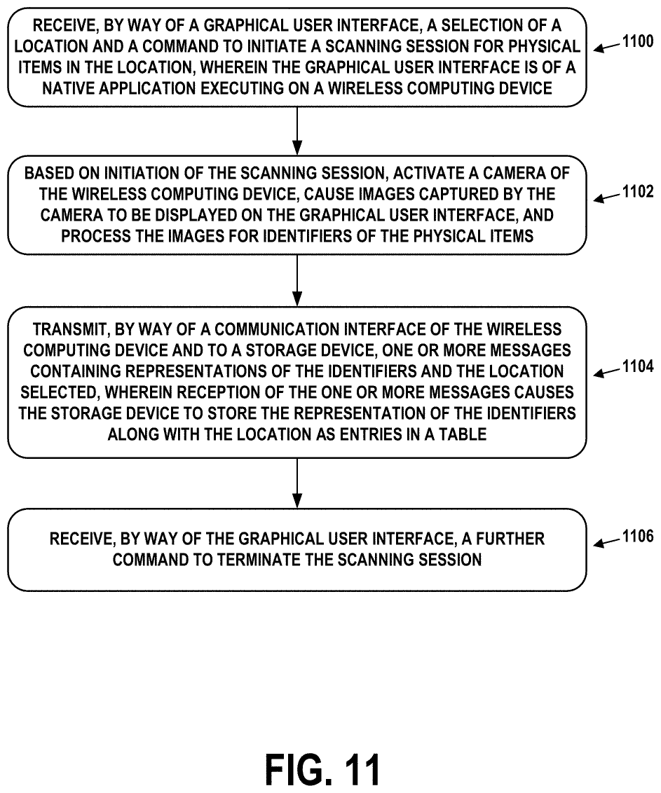

FIG. 11 is a flow chart illustrating an example embodiment. The process illustrated by FIG. 11 may be carried out by a computing device, such as computing device 100. However, the process can be carried out by other types of devices or device subsystems. For example, the process could be carried out by a portable computer, such as a smartphone, laptop, or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve receiving, by way of a graphical user interface, a selection of a location and a command to initiate a scanning session for physical items in the location, wherein the graphical user interface is of a native application executing on a wireless computing device.

Block 1102 may involve, possibly based on initiation of the scanning session, activating a camera of the wireless computing device, causing images captured by the camera to be displayed on the graphical user interface, and processing the images for identifiers of the physical items.

Block 1104 may involve transmitting, by way of a communication interface of the wireless computing device and to a storage device, one or more messages containing representations of the identifiers and the location selected, wherein reception of the one or more messages causes the storage device to store the representation of the identifiers along with the location as entries in a table.

Block 1106 may involve receiving, by way of the graphical user interface, a further command to terminate the scanning session.

In some embodiments, the location specifies a stockroom or a geographic location.

In some embodiments, initiating the scanning session comprises initiating continuation of a previously-initiated scanning session.

In some embodiments, the identifiers of the physical items are bar codes, UPC codes, QR codes, or alphanumeric codes.

Some embodiments may further involve, possibly in response to receiving the further command, displaying, by way of the graphical user interface, respective counts of physical items that were: scanned and expected, scanned and not expected, expected and not scanned, or new.

Some embodiments may further involve: receiving an additional command to download and cache one or more locations for selection; requesting and receiving, by way of the communication interface and from the storage device, a list of the one or more locations for selection; and storing the list of the one or more locations for selection.

Some embodiments may further involve: receiving, by way of the graphical user interface, an instruction to enter offline mode, wherein the native application does not use the communication interface to communicate when in offline mode; and causing the native application to enter offline mode.

In some embodiments, activating the camera, causing the images captured by the camera to be displayed on the graphical user interface, and processing the images for identifiers of the physical items occur while the native application is in offline mode.

Some embodiments may further involve: receiving, by way of the graphical user interface, a further instruction to exit offline mode; and causing the native application to exit offline mode.

In some embodiments, the native application exiting offline mode causes transmission of the one or more messages.

In some embodiments, processing the images for identifiers of the physical items involves: highlighting when an identifier of a physical item is found in the images; displaying, on the graphical user interface, a prompt to confirm that the identifier is for the physical item; and possibly in response to receiving confirmation that the identifier is for the physical item, storing the identifier.

### XI. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A wireless computing device comprising:
a screen;
a camera;
a communication interface;
one or more processors; and
persistent storage containing program instructions that cause the one or more processors to execute a native application, wherein the native application is configured to:
receive, by way of a graphical user interface, a selection of a location and a command to initiate a scanning session for physical items in the location;
based on initiation of the scanning session, activate the camera, cause images captured by the camera to be displayed on the graphical user interface, and process the images for identifiers of the physical items;
transmit, by way of the communication interface and to a storage device, one or more messages containing representations of the identifiers and the location selected, wherein reception of the one or more messages causes the storage device to store the representation of the identifiers along with the location as entries in a table; and
receive, by way of the graphical user interface, a further command to terminate the scanning session.

2. The wireless computing device of claim 1, wherein the location specifies a stockroom or a geographic location.

3. The wireless computing device of claim 1, wherein initiating the scanning session comprises initiating continuation of a previously-initiated scanning session.

4. The wireless computing device of claim 1, wherein the identifiers of the physical items are bar codes, UPC codes, QR codes, or alphanumeric codes.

5. The wireless computing device of claim 1, wherein the native application is further configured to:
in response to receiving the further command, display, by way of the graphical user interface, respective counts of physical items that were: scanned and expected, scanned and not expected, expected and not scanned, or new.

6. The wireless computing device of claim 1, wherein the native application is further configured to:
receive an additional command to download and cache one or more locations for selection;
request and receive, by way of the communication interface and from the storage device, a list of the one or more locations for selection; and
store the list of the one or more locations for selection.

7. The wireless computing device of claim 6, wherein the native application is further configured to:
receive, by way of the graphical user interface, an instruction to enter offline mode, wherein the native application does not use the communication interface to communicate when in offline mode; and
cause the native application to enter offline mode.

8. The wireless computing device of claim 7, wherein activating the camera, causing the images captured by the camera to be displayed on the graphical user interface, and processing the images for identifiers of the physical items occur while the native application is in offline mode.

9. The wireless computing device of claim 8, wherein the native application is further configured to:
receive, by way of the graphical user interface, a further instruction to exit offline mode; and
cause the native application to exit offline mode.

10. The wireless computing device of claim 9, wherein the native application exiting offline mode causes transmission of the one or more messages.

11. The wireless computing device of claim 1, wherein processing the images for identifiers of the physical items comprises:
highlighting when an identifier of a physical item is found in the images;
displaying, on the graphical user interface, a prompt to confirm that the identifier is for the physical item; and
in response to receiving confirmation that the identifier is for the physical item, storing the identifier.

12. A computer-implemented method comprising:
receiving, by way of a graphical user interface, a selection of a location and a command to initiate a scanning session for physical items in the location, wherein the graphical user interface is of a native application executing on a wireless computing device;
based on initiation of the scanning session, activating a camera of the wireless computing device, causing images captured by the camera to be displayed on the graphical user interface, and processing the images for identifiers of the physical items;
transmitting, by way of a communication interface of the wireless computing device and to a storage device, one or more messages containing representations of the identifiers and the location selected, wherein reception of the one or more messages causes the storage device to store the representation of the identifiers along with the location as entries in a table; and
receiving, by way of the graphical user interface, a further command to terminate the scanning session.

13. The computer-implemented method of claim 12, further comprising;
in response to receiving the further command, displaying, by way of the graphical user interface, respective counts of physical items that were: scanned and expected, scanned and not expected, expected and not scanned, or new.

14. The computer-implemented method of claim 12, further comprising:
receiving an additional command to download and cache one or more locations for selection;
requesting, and receiving, by way of the communication interface and from the storage device, a list of the one or more locations for selection; and
storing the list of the one or more locations for selection.

15. The computer-implemented method of claim 14, further comprising:
receive, by way of the graphical user interface, an instruction to enter offline mode, wherein the native application does not use the communication interface to communicate when in offline mode; and
causing the native application to enter offline mode.

16. The computer-implemented method of claim 15, wherein activating the camera, causing the images captured by the camera to be displayed on the graphical user interface, and processing the images for identifiers of the physical items occur while the native application is in offline mode.

17. The computer-implemented method of claim 16, further comprising:
receiving, by way of the graphical user interface, a further instruction to exit offline mode; and
causing the native application to exit offline mode.

18. The computer-implemented method of claim 17, wherein the native application exiting offline mode causes transmission of the one or more messages.

19. The computer-implemented method of claim 12, wherein processing the images for identifiers of the physical items comprises:
highlighting when an identifier of a physical item is found in the images; and
displaying, on the graphical user interface, a prompt to confirm that the identifier is for the physical item; and
in response to receiving confirmation that the identifier is for the physical item, storing the identifier.

20. An article of manufacture including a non-transitory computer-readable medium, having stored thereon program instructions that, upon execution by a wireless computing device, cause the wireless computing device to perform operations comprising:
receiving, by way of a graphical user interface, a selection of a location and a command to initiate a scanning session for physical items in the location;
based on initiation of the scanning session, activating a camera of the wireless computing device, causing images captured by the camera to be displayed on the graphical user interface, and processing the images for identifiers of the physical items;
transmitting, by way of a communication interface of the wireless computing device and to a storage device, one or more messages containing representations of the identifiers and the location selected, wherein reception of the one or more messages causes the storage device to store the representation of the identifiers along with the location as entries in a table; and
receiving, by way of the graphical user interface, a further command to terminate the scanning session.
